(19) United States
(12) Patent Application Publication
(10) Pub. No.: US 2010/0004146 A1
(43) Pub. Date: Jan. 7, 2010

(54) Leak-Off Control Agent

(76) Inventors: Mohan K.R. Panga, Stafford, TX (US); Carlos Abad, Richmond, TX (US); John W. Still, Katy, TX (US); Bruno Drochon, Houston, TX (US)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 12/166,681

(22) Filed: Jul. 2, 2008

(51) Int. Cl. C09K 8/76

(52) U.S. Cl. 507/212

(57) ABSTRACT

A method of controlling leak-off and reducing the concentration of polymers (and/or other materials) in filter cakes formed when oilfield treatment fluids flow through subterranean formation faces involves adding large plate-like degradable and/or non-degradable, particles to polymer or VES-viscosified oilfield treatment fluids, at concentrations of such particles that are less than that required to cover the contacted formation face with a monolayer of such particles. When these large plate-like degradable and/or non-degradable particles are included in the fluid, polymer concentrates to form filter cake only in regions on the formation face (for example fracture faces) not shielded by the large plate-like particles, and the remaining formation face is not covered by concentrated polymer. As a result, the damage due to concentration of polymer and/or other materials in the filter cake during leak-off is reduced, and subsequent clean-up of the filter cake is easier.

### BACKGROUND OF THE INVENTION

The Invention relates to filter cakes on the surfaces of subterranean formations. More particularly it relates to formation of filter cakes that are discontinuous and therefore less damaging and easier to clean up than conventional filter cakes. Most particularly it relates to inclusion in injected fluids of large plate-like particles, much larger than conventional fluid loss control additives, which create regions on the surfaces where leak off does not occur and filter cake does not form.

Subterranean formations routinely come in contact with treatment fluids designed for drilling, fracturing, acidizing, acid fracturing, sand control, water control and other applications. These fluids are injected into the formation at or above the pressure of formation fluids; this pressure difference between the treatment fluid and the reservoir fluid leads to invasion of the formation by the treatment fluid. The treatment fluids (e.g. drilling muds, fracturing fluids, etc.) are sometimes made highly viscous by adding polymers or VES (viscoelastic surfactants) to enable them to widen fractures and/or to carry propping agents, drill cuttings, sand, etc. They also typically contain fluid loss control additives (also called bridging agents or fluid loss additives (FLA's)) to reduce the leak off of fluid to the formation. When the fluids inevitably leak into the formation, the polymers and bridging agents present in the fluid concentrate on the formation face, creating a filter cake. This filter cake can damage the formation and decrease productivity. For example, in fracturing, the filter cake can decrease the conductivity of the fracture. In addition, for VES based treatments, the fluid entering the formation can result in fracture face damage and reduced permeability. Loss of fluid to the formation can also result in creation of water blocks, emulsions, clay swelling, and/or damage due to invading polymer, VES, additives, etc.

As stated, fluid loss to the formation is typically controlled by adding particulates to the fluid that help in reducing leak-off rates. However the concentration of the polymer in the filter cake during leak-off cannot be controlled by adding traditional fluid loss additives; it is proportional to the concentration of the polymer in the fluid. The filter cake formed in this case is continuous, uniform, and covers large areas of the formation. In addition, conventional fluid loss additives, and invading polymer, plug the pores of the formation due to their small size, and cause damage to permeability of the formation. The polymer concentration in the filter cake can be more than ten times the concentration of the polymer in the original fluid. It is almost always desirable, or even necessary, to remove (or “clean up”) the filter cake at some point; it is typically important to break the filter cake to achieve a good clean-up. It would be beneficial to have a way to reduce the amount of filter cake formed and to make it easier to remove filter cake that does form.

### SUMMARY OF THE INVENTION

One embodiment of the Invention is an oilfield treatment method that involves providing an oilfield treatment fluid that can form a filter cake on the face of a subterranean formation penetrated by a wellbore upon contacting the subterranean formation face at a pressure above the formation pressure. Plate-like particles are added to this fluid at a concentration less than that required to cover the formation face with a monolayer of the particles, for example a concentration of from about 0.12 to about 120 kg/m³. The plate-like particles have two dimensions each at least about 0.5 mm, preferably have one dimension at least 2 mm, most preferably have two dimensions at least 2 mm, and have a thickness of less than 0.5 mm The fluid containing the particles is injected into the wellbore above the formation pressure, and a filter cake is allowed to form.

In various embodiments, the particles may be degradable or non-degradable. The particles may be a mixture of particles varying in size and/or composition. The concentration of the particles may be varied during the treatment. The fluid may also contain one or more fluid loss additives, may be viscosified, may contain proppant or gravel, and/or may contain a formation dissolving agent.

In other embodiments, the particles may be made of an oilfield treatment chemical or be made of the precursor of an oilfield treatment chemical. In a preferred embodiment, the fluid may also contain calcium carbonate and the particles may be polyester flakes, for example polyglycolic acid or polylactic acid flakes. The particles may be coated with one or more than one of a surfactant, polymer, charged molecule, adhesive. The fluid may contain one or more dispersants. The fluid may contain a proppant flowback control additive.

The particles may be made, as non-limiting examples, from polyesters, polycarbonates, starches, hydrocarbon polymers, thermoset polymers, metals, minerals, polyamides, terephthalates, naphthalenates, polyvinyl halides, polyvinylidene halides, polyvinyl alcohols, carbohydrates, proteins, waxes, and mixtures of these materials. The particles may be prepared from a film.

In various embodiments, the fluid may be a cement, a drilling fluid, a completion fluid, or a stimulation fluid.

### BRIEF DESCRIPTION OF THE DRAWING

FIG. 1 shows the fluid loss as a function of the square root of time for a guar-based fracturing fluid with and without the large plate-like particles of the Invention.

### DETAILED DESCRIPTION OF THE INVENTION

It should be understood that throughout this specification, when a concentration or amount range is described as being useful, or suitable, or the like, it is intended that any and every concentration or amount within the range, including the end points, is to be considered as having been stated. Furthermore, each numerical value should be read once as modified by the term “about” (unless already expressly so modified) and then read again as not to be so modified unless otherwise stated in context. For example, “a range of from 1 to 10” is to be read as indicating each and every possible number along the continuum between about 1 and about 10. In other words, when a certain range is expressed, even if only a few specific data points are explicitly identified or referred to within the range, or even when no data points are referred to within the range, it is to be understood that the inventors appreciate and understand that any and all data points within the range are to be considered to have been specified, and that the inventors have possession of the entire range and all points within the range.

We have found that adding large plate-like degradable and/or non-degradable particles to polymer-containing oilfield treatment fluids, at concentrations of such particles that are less than that required to cover the contacted formation face with a monolayer of such particles, controls leak-off and reduces the concentration of polymers (and/or other materials) in filter cakes. In addition, when these large plate-like degradable and/or non-degradable particles are included in the fluid, polymer concentrates only in limited regions on the formation face (for example fracture faces), and the remaining formation face not shielded by the large plate-like particles is not covered by concentrated polymer and/or other materials. Such a filter cake is termed “discontinuous”. As a result, the damage due to concentration of polymer in the filter cake during leak-off is reduced, and subsequent clean-up of the filter cake is easier. If the fluid is viscosified with a VES, the large plate-like particles provide reduced VES fluid loss, and, as a result, enhanced fluid efficiency. Note that fluids viscosified with polymers or with VES's may also contain solid particles (for example as components of fluid loss additives (small mica flakes), as weighting agents (barite), or as proppant flow back control agents (fibers)) and/or other polymers (for example as components of fluid loss control agents (starches) or as friction reducers (polyacrylamides)). It is to be understood that a filter cake may include portions of these materials if they are present.

Large plate-like particles have been used in the oilfield. They have been used as the sole solid material in diverting and plugging applications (see U.S. Pat. Nos. 3,979,305 and 4,005,753) and as masking agents to promote differential etching in acid fracturing of sandstones (see for example U.S. Patent Application Publication Nos. 2005/0113263 and 2006/0058197). They have been used in proppant and gravel packs, for example to control fines or proppant migration (see U.S. Pat. No. 5,782,300 and U.S. Patent Application Publication No. 2007/0114031).

In this invention, we use the term “plate-like particle” to describe particles in which one of the dimensions is much smaller than the other two dimensions. These particles may also be described as substantially “uniplanar”. Those skilled in the art will recognize that a dividing line between what constitute “platelets”, on the one hand, and other shapes on the other, tends to be arbitrary, with platelets being distinguished practically from other shapes by having two dimensions significantly larger than the third dimension. As used herein, the terms “platelet” or “platelets” are employed in their ordinary sense, suggesting flatness or extension in two particular dimensions, rather than in one dimension, and include shavings, discs, wafers, films, strips and other shapes. The surfaces defined by the two larger dimensions may be rough or smooth, flat or curved, regular or irregular, parallel or not, and of any shape. Preferably, the platelets will be larger than about 0.5 mm (500 microns) in the longest dimension, more preferably larger than about 1 mm, and most preferably from about 2 mm to about 5 mm. Preferably, the platelets will be larger than about 0.5 mm (500 microns) in the longest two dimensions, more preferably larger than about 1 mm, and most preferably from about 2 mm to about 5 mm in each of the two larger dimensions. Preferably, the shortest dimension will be less than about 0.5 mm, more preferably less than about 0.1 mm, and most preferably less than about 50 microns. A mixture of different sizes and shapes of these particles may also be used. A particularly suitable source of the plate-like particles of the Invention is commercially available films, from which the plate-like particles may be prepared, for example by chopping or cutting.

The plate-like particles of the Invention may be used in an oilfield treatment fluid, for example a fracturing fluid, in a concentration range of from about 0.12 kg/m3 to about 120 kg/m3 (about 1 ppt (pounds per thousand gallons) to about 1000 ppt), preferably in a concentration range of from about 0.12 kg/m3 to about 12 kg/m3 (about 1 ppt to about 100 ppt), and most preferably in the range of about 1.2 kg/m3 to about 60 kg/m3 (about 10 ppt to about 50 ppt).

For conventional fracturing treatments with viscosified fluids, the plate-like particles of the Invention may be used in any stage or stages of the treatment, although they are particularly useful in the PAD. In water frac treatments, the plate-like particles of the Invention may be used in the PAD, in the proppant stages, and during proppant flush stages, and are particularly useful when there is otherwise an excessive amount of fluid lost into the natural fractures.

When the large plate-like particles are added to the fluid, it is observed that the fluid leak off is controlled and the filter cake formed is no longer continuous, as it is in the case of traditional fluid loss additives. It is important to understand that the polymer, and other solids if present, in contact with the plate-like structures does not concentrate where the plates mask the surface, because the plate-like particles do not allow leak-off of filtrate into the formation. As a result, the fluid directly in contact with the plate-like particles does not concentrate polymer (and/or other solids) whereas the regions not in contact with the large plate-like particles are subject to conventional fluid leak-off. At the end of a treatment, the formation face, for example fracture faces in hydraulic fracturing or fracture acidizing, is covered only partially with the filter cake. The remaining part of the formation face is covered by the large plate-like particles. These large plate-like particles may degrade or may easily be removed, creating a pathway for fluids to flow. In some cases the large plate-like particles may be partially or entirely composed of, or may be partially or entirely composed of a material selected to degrade to release, chemicals that may act as breakers or de-crosslinkers for a polymer based fracturing fluid, or as breakers for the micelles or surfactants of a VES fluid. This reduces the viscosity and increases the clean-up from the fracture. Non-limiting examples of chemicals that may be released are acids, bases, alcohols, waxes, esters, chelants, etc. This method provides good fluid loss control and enables much better clean-up than conventional treatment methods. In addition the large plate-like particles may be partially or entirely composed of other components of oilfield treatment fluids, such as waxes, esters, plasticizers, chelants, salts, and mixtures of these materials; alternatively, the large plate-like particles may contain or consist of precursors to such components. The degradation may take place relatively quickly, such that degradation products are returned to the surface if and when fluid is first returned to the surface. In other cases, the degradation may occur more slowly and may continue after the well treatment has been completed and the well is being used for the purpose for which it was drilled (for example during production in a production well or during injection in an injection well).

The large plate-like materials may be used in conjunction with conventional FLA's. This is very common, because otherwise leak-off would not be controlled across regions of the formation face that are not covered by the large plate-like particles. A particularly useful mixture is a blend of sized carbonate, for example calcium carbonate in the size range conventionally used for fluid loss control, and polyester flakes, for example polylactic acid (PLA) or polyglycolic acid (PGA) flakes. Suitable polyesters include those selected from substituted and unsubstituted lactide, glycolide, polylactic acid, polyglycolic acid, copolymers of polylactic acid and polyglycolic acid, copolymers of glycolic acid with other hydroxy-, carboxylic acid-, or hydroxycarboxylic acid-containing moieties, copolymers of lactic acid with other hydroxy-, carboxylic acid-, or hydroxycarboxylic acid-containing moieties, and mixtures of such materials. The amounts are preferably selected so that when it hydrolyzes the polyester produces enough acid to dissolve the carbonate. As an example, a blend of PLA and calcium carbonate having a mass ratio of PLA:calcium carbonate of about 1.3:1 may be used. Higher mass ratios may also be used; however at lower mass ratios, calcium carbonate will be in excess and the lactic acid produced from hydrolysis of the PLA will not be enough to dissolve the calcium carbonate completely. This is less desirable, but within the scope of the Invention. Similarly, PGA and calcium carbonate may be used at a ratio greater than the stoichiometric amount of PGA required to dissolve the calcium carbonate completely.

It is to be understood that although the large plate-like particles of the Invention are normally used at a concentration less than that required to cover the surface of the formation contacted by the fluid with a monolayer of such particles, the large plate-like particles of the Invention may optionally be used at a concentration equal to or greater than that required to cover the surface of the formation.

When the large plate-like particles are present in a fluid, they may also reduce flow of the fluid into natural fractures, for example natural microfractures, in which case they may serve as a diverting agent.

In a dynamic situation, the large plate-like particles may be made to stay preferentially on the formation face by coating them with surfactants, polymers, positive or negatively charged molecules, etc., so that they preferentially adsorb on to the formation face. They may also be coated with a sticky material that provides adhesion to the formation face. Similarly, additives such as dispersants (surfactants, polymers, hydrophobic compounds such as fluorinated surfactants or polymers, etc.) may be added to the treatment fluid or may be coated onto the large plate-like particles to help to disperse the particles uniformly in the fluid.

The large plate-like particles may be added directly to a treatment fluid or they may be dispersed in a liquid in the form of a slurry or suspension that may be added to the treatment fluid. For example, the particles may be dispersed in water, in an aqueous solution, in a solvent, in a solvent solution, and provided as a slurry or suspension. The slurry or suspension may be prepared in advance and taken to the job site or prepared at the job site. Alternatively, the particles may be introduced into the treatment fluid as a solid, for example from a hopper or screw feeder. The large plate-like particles may be used in conjunction with other solids such as traditional fluid loss additives and proppant flow back control additives, for example fibers. In such cases, they may be premixed dry with the other solids or provided as a slurry or suspension with the other solids.

In addition to being degradable or non-degradable, the large plate-like particles of the Invention may be deformable or non-deformable, and may be permeable, semi-permeable or impermeable to the fluid. The plate-like particles may be made of a material or materials that exhibit a thermal transition at a temperature that is encountered downhole; such a temperature, for instance, may be the natural reservoir temperature, or the temperature to which the reservoir or wellbore is cooled or heated by means the injected fluids. Such thermal transitions may be, for instance, glass transitions, melting points, softening points, crystallizations, and others. The existence of such thermal transitions mean that, at a given temperature, the various materials useful in the Invention may be soft, hard, brittle, tough, soluble insoluble or partially soluble when exposed to the conditions (for example pressure and temperature) and/or to the fluids downhole. In addition, the choice of material may be such as to enable a change of thermal and/or physical properties of the material (form, Young's Modulus, surface tension, interfacial tension, total volume, permeability, and others) during use.

As an example of use, to control fluid loss to the formation during conventional fracturing, the large plate-like particles (platelets) of the Invention may be added to various fluid stages of a fracturing treatment, for example with the use of a pod blender, with or without the proppant. For example, the particles may be added to the pad stage of a treatment at a concentration of, for example, from about 3 kg/m³ to about 12 kg/m³ (about 25 ppt to about 100 ppt). As the pad creates the fracture, the fluid leak-off to the formation carries the platelets towards the fracture faces where they cover a portion of the faces. Because the platelets are impermeable, leak-off through the plate-like particles is not possible. This slows down or eliminates the polymer dehydration in the fluid near the regions where platelets are present. If the fluid is viscosified with a polymer, and if the plate-like particles are made of a breaker or are made of a material that releases a breaker, then after the treatment is complete, the platelets degrade, releasing, for example, an acid that breaks the polymer. Since the polymer solution has not been dehydrated as much as it would have been in the absence of the plate-like particles, the flow initiation pressure during the clean-up stage is also lower than it would have been in the case where platelets had not been used to control leak-off. For further leak-off control, the platelets may also be added to the fluid in the proppant stages of the treatment. The platelets may be added to the proppant-carrying fluid in a concentration range, for example, of from about 1.2 kg/m³ to about 6 kg/m³ (from about 10 ppt to about 50 ppt). The leak-off control mechanism is the same as in the pad stage. The decrease in leak-off helps control premature screenout of the proppant due to excessive leak-off.

As another example, the large plate-like particles (platelets) of the Invention may be added to cements, for example at concentrations of from about 0.1 to about 5.0 weight percent.

Many materials, and mixtures of materials, may be used for the formation of the large plate-like particles of the Invention. The exact choice may be dictated by availability and cost, and most particularly by the conditions of use (for example temperature and the composition of the fluid), the intended fate of the particles (for example whether they are intended to be in position permanently, or to degrade or dissolve over time) and what chemicals it may be desirable to release.

Suitable materials for the large plate-like particles include polyesters, for example glycolide, lactide, polylactic acid, polyglycolic acid, polyhydroxybutyrate, polyhydroxyvalerate, polycaprolactone, polyethylene terephthalate, polybutylene terephthalate, 1,4-butane-diol adipinic-dicarbonic and terephthalate copolyester, poly (tetramethylene adipate-coterephthalate), polybutylene succinate/adipate, bisphenol A polycarbonate, Bisphenol F polycarbonate, a copolymer of polylactic acid and polyglycolic acid, a copolymer of glycolic acid with other hydroxyl-, carboxylic acid-, or hydroxycarboxylic acid-containing moieties, a copolymer of lactic acid with other hydroxy-, carboxylic acid or hydroxycarboxylic acid-containing moieties, or mixtures of such materials. These polyesters will generally be degradable, especially in water, by dissolution ands/or hydrolysis.

Additional suitable materials include biodegradable synthetic polymers such as polyester amides, and starch films made of materials such as waxy corn starch, potato starch, yam starch, high-amylose corn starch, wrinkled pea starch, potato amylase, and the like.

Other suitable materials include hydrocarbon polymers such as polystyrene or polymethyl methacrylate, and polyolefins such as polyethylene, polypropylene and the like. Such materials will typically be insoluble and non-degradable in oilfield treatment fluids under oilfield treatment conditions, but will exhibit thermal transitions, such as those described earlier, that can be of use in the downhole environment.

Also suitable are thermoset polymers such as melamine formaldehyde, phenol formaldehyde, epoxy resins, polytetrafluoroethylene, polyvinylidene chloride and polyvinylidene fluoride. In addition, natural materials such as cellulose-based materials (wood, paper, clay-coated paper) or modified natural products such as cellophane, cellulose acetate, etc. Further, metals such as aluminum, copper, tin, iron, and other metals and alloys may be used; metals ands alloys may be malleable or not. Natural minerals may be used, in particular those that may be exfoliated, for example mica and vermiculite.

Films made of polymers may be used, for example polyamides (for example nylons such as CAPRAN™, available from Honeywell, Morris Township, N.J., U.S.A.), polymethyl pentene (PMP), polyethylene terephthalate (PET), and polyethylene naphthalenate (PEN). Other suitable films include MELINEX™, TEONEX™, TETORON™, CRONAR™, and MYLAR™, all available from DuPont Teijin films, Hopewell, Va., U.S.A., and other films such as ACLON™ and ACLAR™ ethylene chlorotrifluoroethylene films available from Honeywell, polyvinyl fluoride TEDLAR™ and polyvinylidene chloride SARAN™, available from DuPont, Wilmington, Del., U.S.A., or mixtures of these materials such as the polyester/polyethylene/ACLAR FILM-O-RAP FR 3300™, available from Bell Fibre Products Corp., Columbus, Ga., U.S.A. Also suitable are degradable, edible or biodegradable films, commonly known as water-soluble films, examples of which include polyvinyl alcohol films, for example CORIAN™, available from DuPont, or MONOSOL™ F100, and MONOSOL™ M-2000, available from MonoSol, Merrillville, Ind., U.S.A.

Other suitable materials are natural polymers that form films; they may be composed, for example, of carbohydrate, protein, solid lipid/wax, or resin. Examples of carbohydrate polymers include various forms of cellulose, such as carboxymethylcellulose (CMC) and hydroxypropyl cellulose (HPC); wheat gluten, starch and dextrins; pectin; pullulan-based materials; and alginates. Proteins currently used include animal and plant proteins such as albumen, corn zein, soy protein isolate, collagen, casein, gelatin, fish myofibrillar protein, keratin, cottonseed protein, peanut protein, and whey protein. Waxes include natural waxes such as beeswax, carnauba wax, candelilla wax, and rice bran wax, and petroleum based waxes such as paraffin wax and polyethylene wax. These waxes may also act as plasticizers; other plasticizers that may be used include glycerol. Lipid based edible films may be used; examples include those containing neutral lipids, fatty acids, natural waxes

Materials that are used as conventional fluid loss additives in finely divided form may also be made into large plate-like particles. An example is the slowly oil-soluble, water-insoluble composition made of a wax and a resin, described in U.S. Pat. No. 4,192,753.

Mixtures of all the above materials may be used; films may be made by extrusion blowing, milling, casting, or other procedures. Such films may be monolayered or multilayered structures obtained by extrusion blowing, or coextrusion blowing, milling, casting or any other such techniques. Large plate-like particles may be made from already-coated materials such as films; examples of coated films, such as silicone-coated polyester films, are those available under the trademark CLEARSIL™, from CPFilms, Martinsville, Va. U.S.A. Films may be reinforced with fibers for improved strength. Coated materials combining metals and plastics are also suitable, such as the aluminized polyethylene/nylon MARVELSEAL™ 360, available from Berry Plastics Corp., Franklin, Mass., U.S.A.

Although some of the preceding discussion emphasized fracturing, the large plate-like particles, discontinuous filter cake, and methods of the Invention may be used in fracturing, gravel packing, combined fracturing and gravel packing, in other treatments such as drilling, fracturing, acidizing, water control, and sand control, and in any other fluids used to treat a subterranean formation. As examples, the large plate-like particles may be used in cements, and may be used for lost circulation control. The invention is equally applicable to wells of any orientation. The invention is suitable for hydrocarbon production wells, and for wells for production of other fluids, such as water or carbon dioxide, or, for example, for injection or storage wells.

The present invention can be understood further from the following example:

### EXAMPLE

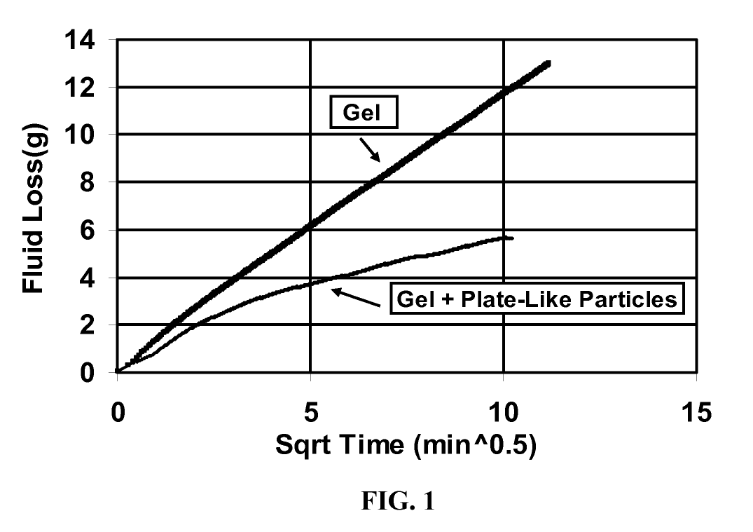

A static fluid loss test was performed in which a fracture fluid containing 3 kg/m³ (25 pounds per thousand gallons) of cross-linked guar gel was leaked through a 2.54 cm (1 inch) core by applying a differential pressure of 6.89 MPa (1000 psi). The same test was repeated with the addition of large plate-like particles to the cross-linked gel at a concentration of 3 kg/m³ (25 pounds per thousand gallons. The particles were about 0.5 by 0.5 mm, and were cut by hand from commercially available polyethylene film. Without the added particles, a thick, uniform filter cake was formed on the core surface. When the large plate-like particles were included in the fluid, the filter cake was very discontinuous; some regions of the core face were covered by the particles and had no polymer visible by eye, and the remainder of the core face was covered by polymer filter cake. FIG. 1 shows that fluid loss was substantially reduced by the addition of the large plate-like particles of the Invention.

We Claim

1. An oilfield treatment method other than acid fracturing of sandstones comprising:
a) providing an oilfield treatment fluid that can form a filter cake on the face of a subterranean formation penetrated by a wellbore upon contacting the subterranean formation face at a pressure above the formation pressure,
b) adding to the fluid plate-like particles having two dimensions each at least about 0.5 mm and a thickness of less than 0.5 mm, the particles being at a concentration less than that required to cover the formation face with a monolayer of the particles,
c) injecting the fluid containing the particles into the wellbore above the formation pressure, and
d) allowing the filter cake to form.

2. The method of claim 1 wherein the particles are degradable.

3. The method of claim 1 wherein the particles are not degradable.

4. The method of claim 1 wherein the particles are a mixture of particles varying in one or more than one of size and composition.

5. The method of claim 1 wherein the concentration of the particles is varied during the treatment.

6. The method of claim 1 wherein the fluid further comprises one or more fluid loss additives.

7. The method of claim 1 wherein the fluid is viscosified.

8. The method of claim 1 wherein the fluid further comprises proppant.

9. The method of claim 1 wherein the fluid further comprises gravel.

10. The method of claim 1 wherein the fluid further comprises a formation dissolving agent.

11. The method of claim 1 wherein the particles have one dimension at least 2 mm.

12. The method of claim 1 wherein the particles have two dimensions each at least 2 mm.

13. The method of claim 1 wherein the particle concentration is from about 0.12 to about 120 kg/m³.

14. The method of claim 1 wherein the particles comprise an oilfield treatment chemical.

15. The method of claim 1 wherein the particles comprise the precursor of an oilfield treatment chemical.

16. The method of claim 1 wherein the fluid further comprises calcium carbonate and the particles comprise polyester flakes.

17. The method of claim 16 wherein the polyester is selected from polyglycolic acid and polylactic acid.

18. The method of claim 1 further wherein the particles are coated with a material selected from the group consisting of surfactants, polymers, charged molecules, adhesives, and mixtures thereof.

19. The method of claim 1 wherein the fluid further comprises one or more dispersants.

20. The method of claim 1 wherein the fluid further comprises a proppant flowback control additive.

21. The method of claim 1 wherein the particles comprise a material selected from the group consisting of polyesters, polycarbonates, starches, hydrocarbon polymers, thermoset polymers, metals, minerals, polyamides, terephthalates, naphthalenates, polyvinyl halides, polyvinylidene halides, polyvinyl alcohols, carbohydrates, proteins, waxes, and mixtures thereof.

22. The method of claim 1 wherein the particles are prepared from a film.

23. The method of claim 1 wherein the fluid is a cement.

24. The method of claim 1 wherein the fluid is a drilling fluid.

25. The method of claim 1 wherein the fluid is a completion fluid.

26. The method of claim 1 wherein the fluid is a stimulation fluid.
